(19) United States
(12) Patent Application Publication
(10) Pub. No.: US 2025/0177815 A1
(43) Pub. Date: Jun. 5, 2025

(54) SPORTS PLAYING SITUATION JUDGEMENT APPARATUS, SPORTS PLAYING SITUATION JUDGEMENT METHOD, AND SPORTS PLAYING SITUATION JUDGEMENT PROGRAM

(71) Applicant: Nippon Telegraph and Telephone Corporation, Tokyo (JP)

(72) Inventors: Seiichi KONYA, Musashino-shi, Tokyo (JP); Shinji FUKATSU, Musashino-shi, Tokyo (JP); Kazu MIYAKAWA, Musashino-shi, Tokyo (JP); Hirokazu KAKINUMA, Musashino-shi, Tokyo (JP); Shota YAMADA, Musashino-shi, Tokyo (JP)

(21) Appl. No.: 18/841,042

(22) PCT Filed: Mar. 8, 2022
(86) PCT No.: PCT/JP2022/010034

§ 371 Date: Aug. 23, 2024

(51) Int. Cl. A63B 24/00; A63B 71/06

(52) U.S. Cl. CPC A63B 24/0021; A63B 71/06; A63B 2024/0025

(57) ABSTRACT

To enable determination of a sport play situation in a sport which a plurality of players play. A sport play situation determination device includes a positional relationship extraction unit, a positional relationship aggregation unit, and an output unit. The positional relationship extraction unit extracts a positional relationship of a plurality of sport players by using a determination expression for determining whether a predetermined sport play situation has been achieved on the basis of a position of each of the plurality of sport players. The positional relationship aggregation unit aggregates the positional relationship of the plurality of sport players extracted by the positional relationship extraction unit and creates a sport play situation display representing the aggregated positional relationship. The output unit presents the sport play situation display created by the positional relationship aggregation unit.

### TECHNICAL FIELD

An aspect of the present invention relates to a sport play situation determination device, a sport play situation determination method, and a sport play situation determination program.

### BACKGROUND ART

In sport games such as soccer, a method of analyzing a play situation of a player by visualizing position information of the player by a heat map is known.

As disclosed in Non Patent Literature 1, for example, it is possible to recognize whether or not a player at a right-side attacking position has played an active part on the basis of a proportion at which the player was within a dashed-line frame at a right upper part including a goal by expressing position information of the player as a heat map.

### CITATION LIST

### Non Patent Literature

Non Patent Literature 1: “Zoku hi maketta notameno sosharu media (in Japanese) (Sequel: Social Media for Non-marketers)”, Nikkei Computer, issued on May 14, 2015, (no. 886), pp. 62-65, ISSN0285-4619

### SUMMARY OF INVENTION

### Technical Problem

In the aforementioned play situation analysis, the goal position is implicitly assumed to be fixed, and the position of the player is regarded as a distance from the goal as it is. Therefore, the position of each player can be determined as a play situation as it is.

However, if this technique is applied to martial arts such as boxing, the position of each player alone is not directly linked to the play situation and is thus not directly linked to determination of the situation. A situation in which a player is cornered against a corner or a rope side, a situation in which a player is pushed by a counterpart pressure, and the like are conceivable in boxing, for example, and it is not possible to determine these situations if heat maps are created on the basis of position information of the individual players.

This is not solved by superimposing heat maps of the positions of two players. For example, a heat map of a motion of a player a cornering a player b against a rope side may become the same heat map of a motion of the player b who has stayed near the rope side moving away from the rope side.

The present invention focused on the above circumstances, and an object thereof is to provide a sport play situation determination device, a sport play situation determination method, and a sport play situation determination program capable of determining a sport play situation such as superiority and inferiority in a sport which a plurality of players play.

### Solution to Problem

In order to solve the above problem, a sport play situation determination device according to an aspect of the present invention includes a positional relationship extraction unit, a positional relationship aggregation unit, and an output unit. The positional relationship extraction unit extracts a positional relationship of a plurality of sport players by using a determination expression for determining whether a predetermined sport play situation has been achieved on the basis of a position of each of the plurality of sport players. The positional relationship aggregation unit aggregates the positional relationship of the plurality of sport players extracted by the positional relationship extraction unit and creates a sport play situation display representing the aggregated positional relationship. The output unit presents the sport play situation display created by the positional relationship aggregation unit.

### Advantageous Effects of Invention

According to an aspect of the present invention, it is possible to provide a sport play situation determination device, a sport play situation determination method, and a sport play situation determination program capable of determining a sport play situation which is a play situation regarding superiority, inferiority, and the like in a sport which a plurality of players are playing.

### BRIEF DESCRIPTION OF DRAWINGS

FIG. 1 is a block diagram illustrating an example of a hardware configuration of a sport play situation determination device according to a first embodiment of the present invention.

FIG. 2 is a block diagram illustrating a software configuration of the sport play situation determination device according to the first embodiment.

FIG. 3 is a diagram illustrating an example of a storage configuration of a position information table stored in a position information storage unit in FIG. 2.

FIG. 4 is a diagram illustrating an example of a storage configuration of a positional relationship table stored in a positional relationship storage unit in FIG. 2.

FIG. 5 is a diagram illustrating an example of a storage configuration of quantization table stored in an aggregation result storage unit in FIG. 2.

FIG. 6 is a diagram illustrating an example of a storage configuration of a two-dimensional histogram stored in the aggregation result storage unit in FIG. 2.

FIG. 7 is a diagram illustrating an example of a quantization method of player position coordinates.

FIG. 8 is a flowchart illustrating an example of operations of the sport play situation determination device according to the first embodiment.

FIG. 9 is a flowchart illustrating details of a positional relationship extraction sub-routine in FIG. 8.

FIG. 10 is a schematic view for explaining a corner region and a rope-side region.

FIG. 11 is a schematic view for explaining a corner cornering condition.

FIG. 12 is a schematic view for explaining a corner cornering range in FIG. 11.

FIG. 13 is a schematic view for explaining a rope-side cornering condition.

FIG. 14 is a flowchart illustrating details of a positional relationship aggregation sub-routine in FIG. 8.

FIG. 15 is a diagram illustrating an example of storage content in the position information table.

FIG. 16 is a schematic view illustrating motions of two players corresponding to the storage content in FIG. 15.

FIG. 17 is a diagram illustrating an example of storage content in the positional relationship table.

FIG. 18 is a diagram illustrating an example of storage content in the quantization table.

FIG. 19 is a diagram illustrating an example of storage content in the two-dimensional histogram.

FIG. 20 is a diagram illustrating an example of a heat map of each player.

FIG. 21 is a diagram illustrating an example of storage content in the position information table.

FIG. 22 is a schematic view illustrating motions of two players corresponding to the storage content in FIG. 21.

FIG. 23 is a diagram illustrating an example of storage content in the positional relationship table.

FIG. 24 is a diagram illustrating an example of storage content in the quantization table.

FIG. 25 is a diagram illustrating an example of a heat map of each player.

FIG. 26 is a diagram illustrating a motion of each player by a heat map based on a conventional method.

FIG. 27 is a diagram illustrating an example of a storage configuration of an aggregation table stored in an aggregation result storage unit of a sport play situation determination device according to a second embodiment of the present invention.

FIG. 28 is a flowchart illustrating details of a positional relationship extraction sub-routine according to the second embodiment.

FIG. 29 is a schematic view for explaining a motion of each player.

FIG. 30 is a flowchart illustrating details of a positional relationship aggregation sub-routine according to the second embodiment.

FIG. 31 is a diagram illustrating an example of storage content in a position information table.

FIG. 32 is a schematic view illustrating motions of two players corresponding to the storage content in FIG. 31.

FIG. 33 is a diagram illustrating an example of storage content in a positional relationship table.

FIG. 34 is a diagram illustrating an example of storage content in an aggregation table.

FIG. 35 is a diagram illustrating an example of a line graph.

FIG. 36 is a diagram illustrating an example of storage content in the position information table.

FIG. 37 is a schematic view illustrating motions of two players corresponding to the storage content in FIG. 36.

FIG. 38 is a diagram illustrating an example of storage content in the positional relationship table.

FIG. 39 is a diagram illustrating an example of storage content in the aggregation table.

FIG. 40 is a diagram illustrating an example of a line graph.

### DESCRIPTION OF EMBODIMENTS

Hereinafter, embodiments according to the present invention will be described with reference to the drawings.

### First Embodiment

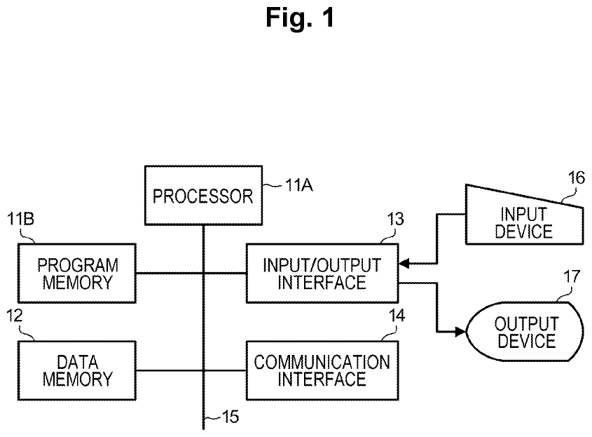

FIG. 1 is a block diagram illustrating an example of a hardware configuration of a sport play situation determination device according to a first embodiment of the present invention.

### (Configuration Example)

The sport play situation determination device is constituted by a personal computer (PC), for example, and has a processor 11A such as a central processing unit (CPU), for example. The processor 11A may be a multi-core/multi-thread processor and can execute a plurality of pieces of processing in parallel. Also, a program memory 11B, a data memory 12, an input/output interface 13, and a communication interface 14 are connected to the processor 11A via a bus 15 in the sport play situation determination device. Note that although not illustrated in the drawing, the sport play situation determination device may include a clock that counts a current time.

The program memory 11B serving as a storage medium is obtained by using, for example, a combination of a nonvolatile memory into/from which data can be written/read at any time, such as a hard disk drive (HDD) or a solid state drive (SSD), and a nonvolatile memory such as a read only memory (ROM). The program memory 11B stores programs necessary for the processor 11A to execute various types of processing. The programs include a sport play situation determination program according to the first embodiment in addition to an operating system (OS) and an application program.

The data memory 12 is a storage including, as a storage medium, a combination of a nonvolatile memory to/from which data can be written/read at any time, such as an HDD or SSD, and a volatile memory such as a random access memory (RAM), for example. The data memory 12 is used to store data acquired and created in the process of performing various types of processing.

The input/output interface 13 is an interface with the input device 16 and the output device 17.

The input device 16 includes a keyboard, a pointing device, and the like for a user to input an instruction to the processor 11A. Also, the input device 16 may include a camera that inputs video data. Furthermore, the input device 16 can include a reader for reading a file or data of a document to be stored in the data memory 12 from a memory medium such as a USB memory, and a disk device for reading such a file or data from a disk medium.

The output device 17 includes a display that displays output data to be presented to the user from the processor 11A, a printer that prints the output data, and the like. Furthermore, the output device 17 can include a speaker that outputs voice data and music data.

The communication interface 14 is a wired or wireless communication unit for connecting to a network such as a local area network (LAN) or the Internet (not illustrated), which is not illustrated.

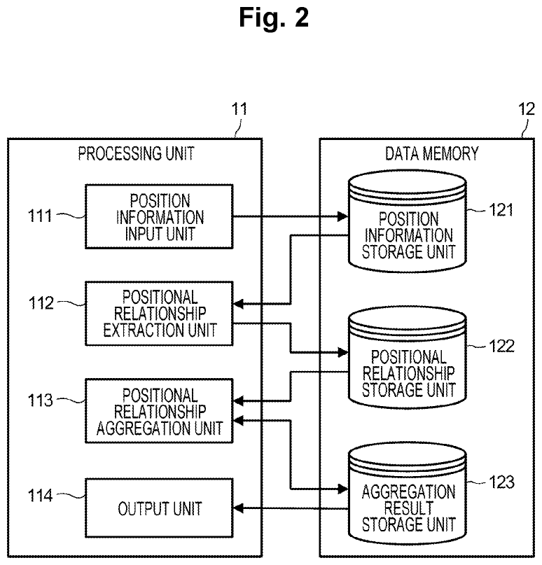

FIG. 2 is a block diagram illustrating a software configuration of the sport play situation determination device in association with the hardware configuration illustrated in FIG. 1.

The processing unit 11 is constituted by the processor 11A and the program memory 11B and includes, as processing functional units based on software, a position information input unit 111, a positional relationship extraction unit 112, a positional relationship aggregation unit 113, and an output unit 114. Each of these processing functional units is implemented by causing the processor 11A to execute a program stored in the program memory 11B. The processing unit 11 may be implemented in other various forms including an integrated circuit including an application specific integrated circuit (ASIC), a digital signal processor (DSP), and a field-programmable gate array (FPGA).

Also, the storage region of the data memory 12 includes a position information storage unit 121, a positional relationship storage unit 122, and an aggregation result storage unit 123.

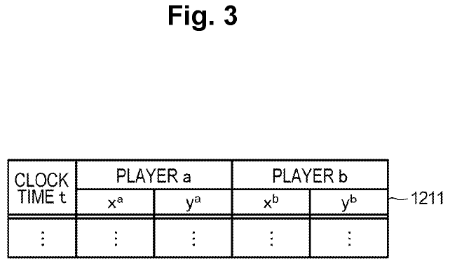

The position information storage unit 121 stores, in a time-series manner, position information of each player who is a target of determination of a sport play situation that is a play situation such as superiority, inferiority, and the like in a sport which a plurality of players play. FIG. 3 is a diagram illustrating an example of a storage configuration of a position information table 1211 stored in the position information storage unit 121. As illustrated in FIG. 3, the position information storage unit 121 can store, in a table form, x and y coordinates indicating the position of each player to correspond to a clock time t. In boxing, for example, coordinate values obtained by defining one of ring corners as an origin 0 and standardizing a corner that is adjacent to the corner as a coordinate value 1 can be used.

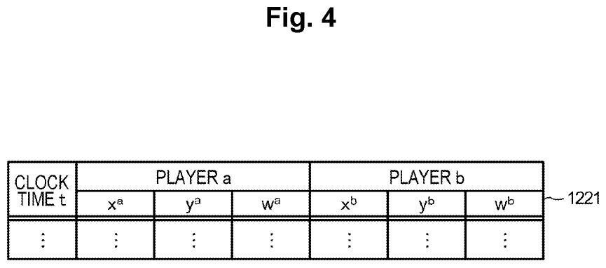

The positional relationship storage unit 122 stores, in a time-series manner, the positional relationship determined on the basis of the position of each player. FIG. 4 is a diagram illustrating an example of a storage configuration of a positional relationship table 1221 stored in the positional relationship storage unit 122. As illustrated in FIG. 4, the positional relationship storage unit 122 can store, in a table form, x and y coordinates indicating the position of each player and the positional relationship w determined on the basis of the position to correspond to the clock time t.

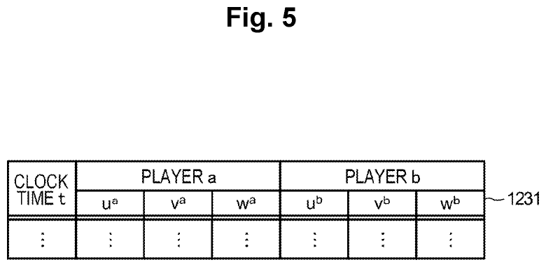

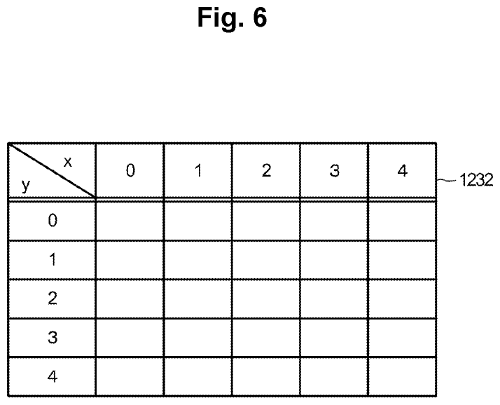

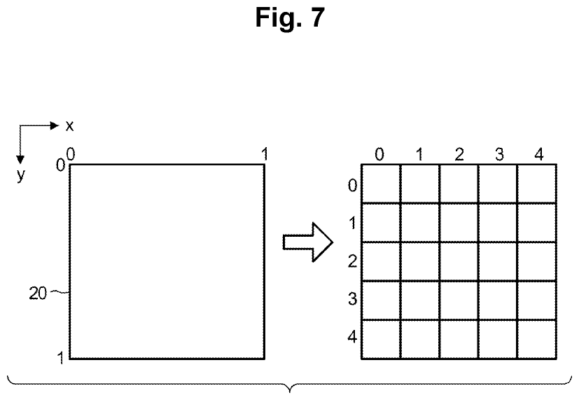

The aggregation result storage unit 123 stores an aggregation result obtained by aggregating a quantization result obtained by quantizing the positional relationship. FIG. 5 is a diagram illustrating an example of a storage configuration of a quantization table 1231 stored in the aggregation result storage unit 123. In addition, FIG. 6 is a diagram illustrating an example of a storage configuration of a two-dimensional histogram 1232 stored in the aggregation result storage unit 123. As illustrated in FIG. 5, the aggregation result storage unit 123 can store, in a table form, u and v values obtained by quantizing the position coordinates of each player and the positional relationship w to correspond to the clock time t. FIG. 7 is a diagram illustrating an example of a method for quantizing the position coordinates of each player. For example, x and y coordinates of (0, 0) to (1, 1) in a boxing ring region 20 are quantized to 5×5 sectioned regions (0, 0) to (4, 4) from 0 to 4 in the present embodiment. As illustrated in FIG. 7, the aggregation result storage unit 123 stores the two-dimensional histogram created from the quantized positional relationship w. Furthermore, the aggregation result storage unit 123 may store a heat map which is a grayscale image in accordance with the two-dimensional histogram value.

Note that although not particularly illustrated in FIG. 2, the data memory 12 includes a temporary storage unit for holding a setting value necessary for each unit of the processing unit 11 to perform processing, temporary data that each unit of the processing unit 11 creates during processing, and the like.

In addition, the position information input unit 111 of the processing unit 11 acquires position information of each player who is a target of determination of a sport play situation that is a play situation such as superiority, inferiority, and the like in a sport which a plurality of players play, and causes the position information storage unit 121 of the data memory 12 to store the acquired position information. For example, the position information input unit 111 can acquire position information as position data input from the input device 16 or provided from the outside via a network that is received by the communication interface 14. Moreover, the position information input unit 111 may include a function of analyzing video data input from a camera as the input device 16 and acquiring position information of each player.

The position information input unit 111 further acquires initial setting values such as a heat map size (M, N), determination expression parameter setting values (K1, θ), and the like input by the input device 16 or provided from the outside via the network that is received by the communication interface 14 and causes the temporary storage unit, which is not illustrated, of the data memory 12 to store the initial setting values.

The positional relationship extraction unit 112 extracts the positional relationship w of the plurality of sport players by using the determination expression for determining whether a predetermined sport play situation has been achieved on the basis of the position of each of the plurality of sport players stored in the position information storage unit 121. The determination expression will be described in detail in the description of operation examples below. The positional relationship extraction unit 112 causes the positional relationship storage unit 122 to store the extracted positional relationship w.

The positional relationship aggregation unit 113 quantizes the positional relationship w stored in the positional relationship storage unit 122 and causes the aggregation result storage unit 123 to store the quantization result. The positional relationship aggregation unit 113 further creates a sport play situation display from the quantized positional relationship w stored in the aggregation result storage unit 123 and causes the aggregation result storage unit 123 to store the sport play situation display. For example, the positional relationship aggregation unit 113 creates a two-dimensional histogram from the quantized positional relationship w and creates, as the sport play situation display, a heat map based on the two-dimensional histogram value.

The output unit 114 causes the output device 17 to display the heat map, for example, which is the sport play situation display stored in the aggregation result storage unit 123. Alternatively, the output unit 114 may output the sport play situation display to the outside through the communication interface 14.

### (Operation Example)

Next, processing operations of the sport play situation determination device configured as described above will be described. Note that in the present embodiment, a situation in which a player is cornering a counterpart against a corner or a rope side in boxing will be described as an example. In other words, the number of the plurality of players is “two”.

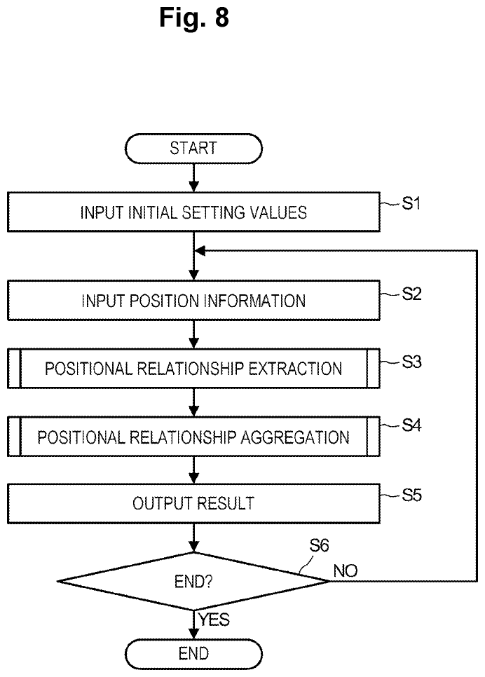

FIG. 8 is a flowchart illustrating an example of operations of the sport play situation determination device according to the first embodiment. The processor 11A of the sport play situation determination device can execute the processing illustrated in the flowchart by executing a sport play situation determination program stored in advance in the program memory 11B, for example.

The processor 11A operates as the position information input unit 111 first and inputs initial setting values such as a heat map size (M, N), determination expression parameter setting values (K1, θ), and the like (Step S1). The processor 11A causes a temporary storage unit, which is not illustrated, of the data memory 12 to store the initial setting values.

Thereafter, the processor 11A operates as the position information input unit 111 and inputs position information of the plurality of players (Step S2). The position information at the current point may be input every time, or position information during an arbitrary period may be input at once as a file. Hereinafter, a case in which position information during an arbitrary period is input and a sport play situation during the arbitrary period is determined will be described as an example. Here, coordinates of a player a and a player b at the clock time t will be described below.

$$( {x}_{t}^{a} , {y}_{t}^{a} ) , ( {x}_{t}^{b} , {x}_{t}^{b} ) \qquad [ Math . 1 ]$$

Here, t=0, 1, . . . , N−1. Also, the coordinate value is assumed to be standardized to “0” to “1”. The processor 11A causes the position information storage unit 121 to store position information of the players a and b.

Thereafter, the processor 11A executes processing of a positional relationship extraction subroutine (Step S3). In the position relationship extraction sub-routine, the processor 11A operates as the positional relationship extraction unit 112 and determines whether the positional relationship w in which one of the players is cornering the counterpart player against the corner or the rope side has been achieved as a predetermined sport play situation on the basis of the position of each of the players a and b. Details of the positional relationship extraction sub-routine will be described.

After the processing of the positional relationship extraction sub-routine ends, the processor 11A further executes the processing of the positional relationship aggregation sub-routine (Step S4). In the positional relationship aggregation sub-routine, the processor 11A operates as the positional relationship aggregation unit 113, quantizes the positional relationship w, and creates a heat map as a sport play situation display from the quantized positional relationship w. Details of the positional relationship aggregation sub-routine will be described later.

After the processing of the positional relationship aggregation sub-routine ends, the processor 11A operates as the output unit 114, and outputs the heat map, for example, causes the output device 17 to display the heat map (Step S5).

Thereafter, the processor 11A determines whether or not to end the processing (Step S6). For example, the processor 11A can perform the end determination by determining whether or not an end instruction has been input by a user's predetermined operation on the input device 16. In a case where the processing is determined not to be ended yet, the processor 11A moves on to the above processing in Step S2 and repeats the above processing. Also, in a case where the processing is determined to be ended, the processor 11A ends the processing illustrated in the flowchart.

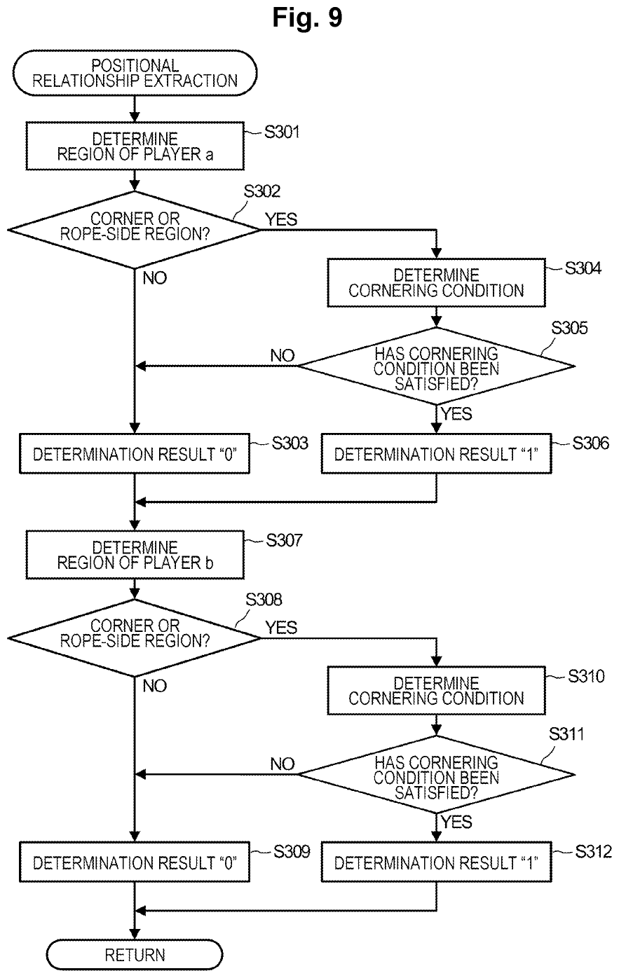

FIG. 9 is a flowchart illustrating details of the positional relationship extraction sub-routine executed as Step S3 above. Here, the extracted positional relationship w is a positional relationship in which one of the players is cornering the counterpart player against a corner or a rope side. In the positional relationship extraction sub-routine, the positional relationship in which the player a is cornering the player b against a corner or a rope side is determined first, and the positional relationship in which the player b is cornering the player a against a corner or a rope side on the contrary is then determined.

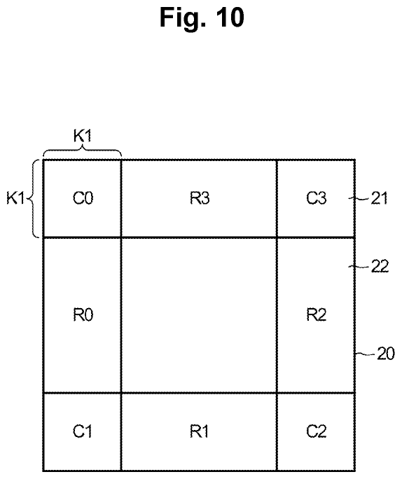

In other words, the processor 11A determines a region of the player a first (Step S301). FIG. 10 is a schematic view for explaining corner regions 21 and rope-side regions 22 of a ring. As illustrated in FIG. 10, the processor 11A sets C0 to C3 as corner regions 21 and R0 to R3 as rope-side regions 22 in the ring region 20 on the basis of a determination expression parameter setting value K1 stored in the temporary storage unit. Then, the processor 11A determines, by the following determination expression, whether or not the coordinates of the player a at each clock time stored in the position information table 1211 of the position information storage unit 121 are located in these corner regions 21 or the rope-side regions 22.

$$C 0 region condition : {x}_{t}^{a} \leq K 1 , {y}_{t}^{a} \leq K 1 \qquad [ Math . 2 ]$$

$$C 1 region condition : {x}_{t}^{a} \leq K 1 , 1 - {y}_{t}^{a} \leq K 1$$

$$C 2 region condition : 1 - {x}_{t}^{a} \leq K 1 , 1 - {y}_{t}^{a} \leq K 1$$

$$C 3 region condition : 1 - {x}_{t}^{a} \leq K 1 , {y}_{t}^{a} \leq K 1$$

$$R 0 region condition : {x}_{t}^{a} \leq K 1 , K 1 < {y}_{t}^{a} < 1 - K 1$$

$$R 1 region condition : K 1 < {x}_{t}^{a} < 1 - K 1 , 1 - {y}_{t}^{a} \leq K 1$$

$$R 2 region condition : 1 - {x}_{t}^{a} \leq K 1 , K 1 < {y}_{t}^{a} < 1 - K 1$$

$$R 3 region condition : K 1 < {x}_{t}^{a} < 1 - K 1 , {y}_{t}^{a} \leq K 1$$

The processor 11A determines whether or not a determination result indicating that the player a is located in any of the corner regions 21 or the rope-side regions 22 at each clock time t has been obtained (Step S302). In other words, the processor 11A makes determination of YES in Step S302 if the coordinates of the player a coincide with any of the above determination expression at a clock time t.

For the clock time at which it is determined that the player a is not located in any of the corner regions 21 or the rope-side regions 22, that is, a Ci region condition and a Ci cornering condition (i=0, . . . , 3) are not satisfied, the processor 11A obtains a determination result at the clock time as “0” (Step S303). Then, the processor 11A associates the clock time t and the coordinates (x^{a}, y^{a}) of the player a at the clock time t in the position information table 1211 of the position information storage unit 121 and stores the determination result “0” as a positional relationship w^{a}.

On the other hand, for the clock time at which it is determined that the player a is located in any of the corner regions 21 or the rope-side region 22, that is, the Ci region condition and the Ci cornering condition (i=0, . . . , 3) are satisfied, the processor 11A further determines the cornering condition of the player a (Step S304).

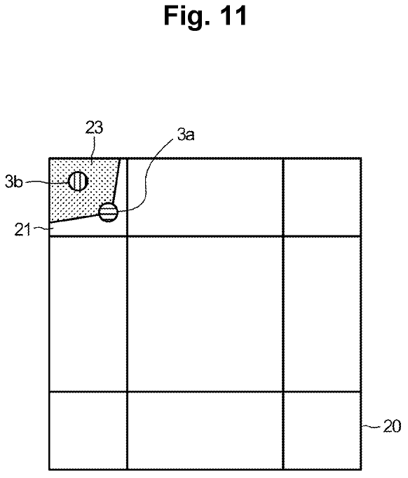

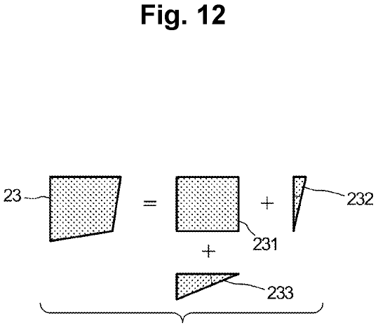

FIG. 11 is a schematic view for explaining a corner cornering condition. In FIG. 11, the reference sign 3a represents the player a, the reference sign 3b represents the player b, and FIG. 11 thus illustrates an example in which the player a (3a) is cornering the player b (3b) in a corner region 21 (C0). In a case where it is determined that the player a (3a) is located in a corner region 21, the processor 11A sets a corner cornering range 23 in the corner region 21 in which the player a (3a) is determined to be located, on the basis of the determination expression parameter setting value θ stored in the temporary storage unit. FIG. 12 is a schematic view for explaining the corner cornering range 23. As illustrated in FIG. 12, the corner cornering range 23 is constituted by a rectangle 231 including the corner coordinates of the ring region 20 and the coordinates of the player a (3a) as diagonals and right-angle triangles 232 and 233 at an angle C including the coordinates of the player a (3a) as a vertex. The processor 11A determines, by the following determination expression, whether or not the coordinates (x^{b}, y^{b}) of the counterpart player b (3b) at the corresponding clock time stored in the position information table 1211 of the position information storage unit 121 is located within the corner cornering range 23 in the corner region 21 where it is determined that the player a (3a) is located.

$$C 0 cornering condition : {x}_{t}^{b} < {x}_{t}^{a} + ( {y}_{t}^{a} - {y}_{t}^{b} ) \cdot tan θ , {y}_{t}^{b} < {y}_{t}^{a} or {x}_{t}^{b} < {x}_{t}^{a} , {y}_{t}^{b} < {y}_{t}^{a} + ( {x}_{t}^{a} - {x}_{t}^{b} ) \cdot tan θ \qquad [ Math . 3 ]$$

$$C 1 cornering condition : {x}_{t}^{b} < {x}_{t}^{a} - ( {y}_{t}^{a} - {y}_{t}^{b} ) \cdot tan θ , {y}_{t}^{a} < {y}_{t}^{b} or {x}_{t}^{b} < {x}_{t}^{a} , {y}_{t}^{a} - ( {x}_{t}^{a} - {x}_{t}^{b} ) \cdot tan θ < {y}_{t}^{b}$$

$$C 2 cornering condition : {x}_{t}^{a} + ( {y}_{t}^{a} - {y}_{t}^{b} ) \cdot tan θ < {x}_{t}^{b} , {y}_{t}^{a} < {y}_{t}^{b} or {x}_{t}^{a} < {x}_{t}^{b} , {y}_{t}^{a} + ( {x}_{t}^{α} - {x}_{t}^{b} ) \cdot tan θ < {y}_{t}^{b}$$

$$C 3 cornering condition : {x}_{t}^{a} - ( {y}_{t}^{a} - {y}_{t}^{b} ) \cdot tan θ < {x}_{t}^{b} , {y}_{t}^{b} < {y}_{t}^{a} or {x}_{t}^{a} < {x}_{t}^{b} , {y}_{t}^{b} < {y}_{t}^{a} - ( {x}_{t}^{a} - {x}_{t}^{b} ) \cdot tan θ$$

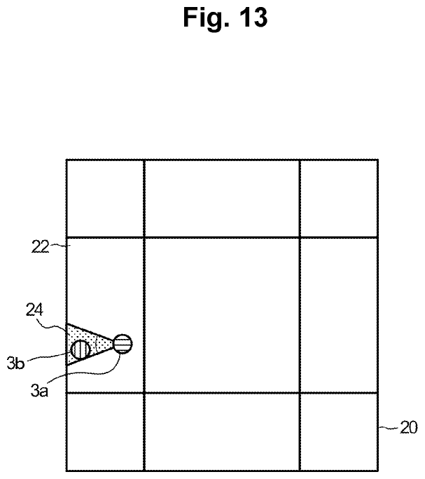

FIG. 13 is a schematic view for explaining rope-side cornering condition. FIG. 13 illustrates a situation in which the player a (3a) is cornering the player b (3b) in the rope-side region 22 (R0). In a case where it is determined that the player a (3a) is located in a rope-side region 22, the processor 11A sets a rope-side cornering range 24 in the rope-side region 22 in which it is determined that the player a (3a) is located, on the basis of the determination expression parameter setting value θ stored in the temporary storage unit. As illustrated in FIG. 13, the rope-side cornering range 24 is set as a right-angle triangle of an angle 20 including the coordinates of the player a (3a) as a vertex. The processor 11A determines, by the following determination expression, whether or not the coordinates (x^{b}, y^{b}) of the counterpart player b(3b) at the clock time stored in the position information table 1211 of the position information storage unit 121 is located within the rope-side cornering range 24 in the rope-side region 22 in which it is determined that the player a (3a) is located.

$$C 0 cornering condition : {x}_{t}^{b} < {x}_{t}^{a} , \vert {y}_{t}^{a} - {y}_{t}^{b} \vert < ( {x}_{t}^{a} - {x}_{t}^{b} ) \cdot tan θ \qquad [ Math . 4 ]$$

$$R 1 cornering condition : \vert {x}_{t}^{a} - {x}_{t}^{b} \vert < - ( {y}_{t}^{a} - {y}_{t}^{b} ) \cdot tan θ , {y}_{t}^{a} < {y}_{t}^{b}$$

$$R 2 cornering condition : {x}_{t}^{a} < {x}_{t}^{b} , \vert {y}_{t}^{a} - {y}_{t}^{b} \vert < - ( {x}_{t}^{a} - {x}_{t}^{b} ) \cdot tan θ$$

$$R 3 cornering condition : \vert {x}_{t}^{a} - {x}_{t}^{b} \vert < ( {y}_{t}^{a} - {y}_{t}^{b} ) \cdot tan θ , {y}_{t}^{b} < {y}_{t}^{a}$$

The processor 11A determines whether or not the cornering determination condition corresponding to the region in which it is determined that the player a (3a) is located has been satisfied (Step S305). For the clock time at which it is determined that the cornering condition has not been satisfied, the processor 11A moves on to the above processing in Step S303 and obtains the determination result as “0”.

On the other hand, for the clock time t at which it is determined that the following condition is satisfied, the processor 11A obtains the determination result as “1” (Step S306). Then, the processor 11A associates the clock time t and the coordinates (x^{a}, y^{a}) of the player a at the clock time t in the position information table 1211 of the position information storage unit 121 and stores the determination result “1” as a positional relationship w^{a}.

As described above, the processor 11A can store, in the position information table 1211 of the position information storage unit 121, the positional relationship w^{a} of the player a=1 for the clock time at which the Ci region condition and the Ci cornering condition (i=0, . . . , 3) are satisfied or the Ri region condition and the Ri cornering condition (i=0, . . . , 3) are satisfied or the positional relationship w^{a}=0 for the other clock times.

After the positional relationship w^{a} for the player a is determined in this manner, the processor 11A further determines a positional relationship w^{b} for the player b in a similar procedure to that performed for the player a. In other words, the processor 11A executes processing in Steps S307 to S312 similarly to the processing in Step S301 to S306 with the coordinates of the player a and the player b replaced. In this manner, the processor 11A can store, in the position information table 1211 of the position information storage unit 121, the positional relationship w^{b} of the player b=1 for the clock time at which the Ci region condition and the Ci cornering condition (i=0, . . . , 3) are satisfied or the Ri region condition and the Ri cornering condition (i=0, . . . , 3) are satisfied or the positional relationship w^{b}=0 for the other clock times.

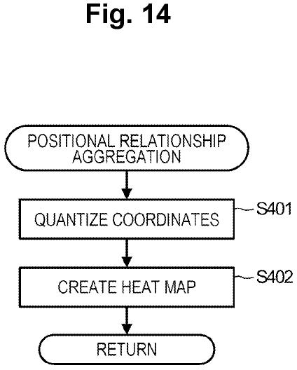

FIG. 14 is a flowchart illustrating details of the positional relationship aggregation sub-routine in FIG. 8. The processor 11A quantizes the coordinates of the position of each of the players a and b at each clock time t stored in the position information table 1211 of the position information storage unit 121 in accordance with the heat map size (M, N) stored in the temporary storage unit (Step S401). Here, the processor 11A obtains the quantized coordinates of the player expressed as follows.

$$( {u}_{t}^{j} , {v}_{t}^{j} ) , ( j = a or b ) \qquad [ Math . 5 ]$$

The quantized coordinates of the player is obtained as follows.

$${u}_{t}^{j} = min ( ⌈ {x}_{t}^{j} \cdot M ⌉ , M - 1 ) \qquad [ Math . 6 ]$$

$${v}_{t}^{j} = min ( ⌈ {y}_{t}^{j} \cdot N ⌉ , N - 1 )$$

The processor 11A stores, in the quantization table 1231 of the aggregation result storage unit 123, the thus quantized position coordinates of the player and the positional relationship w in association with the clock time t.

Next, the processor 11A creates a heat map in accordance with the quantized position coordinates (Step S402). Thereafter, the processor 11A ends the processing of the positional relationship aggregation sub-routine and moves on to the above processing in Step S5.

Specifically, in the above heat map creation processing in Step S402, the processor 11A creates a two-dimensional histogram 1232 from the quantized position coordinates and the positional relationship w of the players, that is, aggregates the positional relationship of the players in the clock time direction. Then, the processor 11A causes the aggregation result storage unit 123 to store the two-dimensional histogram 1232. A grayscale image in accordance with the value of the two-dimensional histogram 1232 is a heat map. Therefore, the processor 11A may create an actual image of the heat map or may stop at the creation of the two-dimensional histogram 1232 which is a basis of the heat map. In the latter case, the grayscale image in accordance with the value of the two-dimensional histogram 1232 may be created in the next processing of outputting results in Step S5.

Next, operations of the sport play situation determination device will be described in a specific example. Here, description will be given on the assumption of the heat map size (M, N)=(5, 5) and the setting values (K1=0.4, θ=15°), for example.

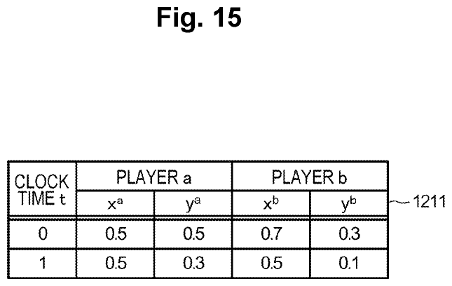

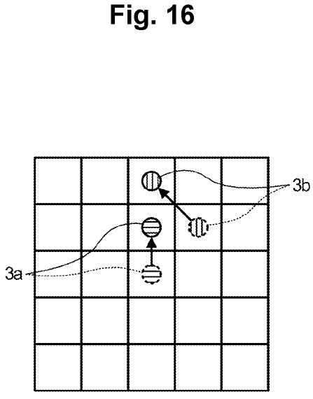

FIG. 15 is a diagram illustrating an example of storage content in the position information table 1211. FIG. 16 is a schematic view illustrating motions of two players corresponding to the storage content in FIG. 15. In FIG. 16, the dashed-line circles are the positions of the players 3a and 3b at the clock time t=0, while the solid-line circles are the positions of the players 3a and 3b at the clock time t=1.

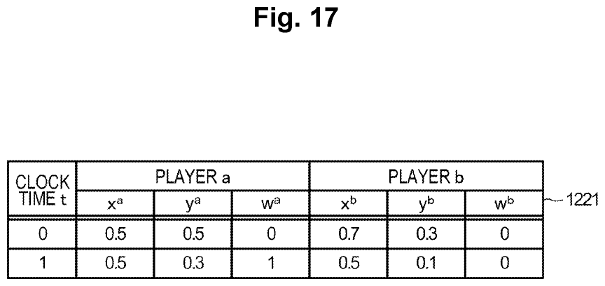

In this example, both the players 3a and 3b do not satisfy the region condition at the clock time t=0, and the positional relationship is thus w^{a}=w^{b}=0. On the other hand, the player 3a satisfies the R3 region condition and also satisfies the R3 cornering condition at the clock time t=1, and the positional relationship is thus w^{a}=1. However, the player 3b satisfies the R3 region condition while it does not satisfy the R3 cornering condition, and the positional relationship is thus w^{b}=0. As a result, the positional relationship table 1221 is as illustrated in FIG. 17.

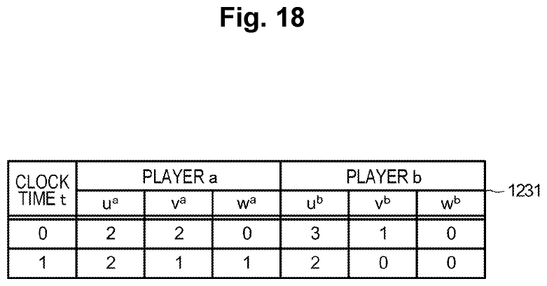

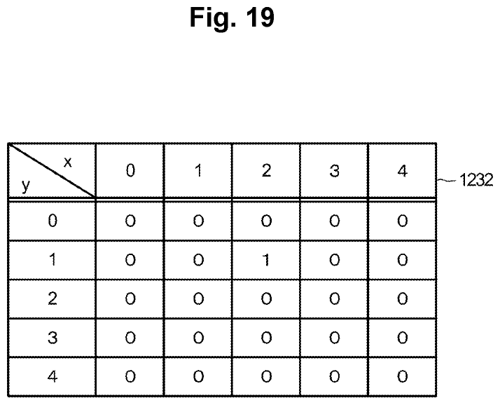

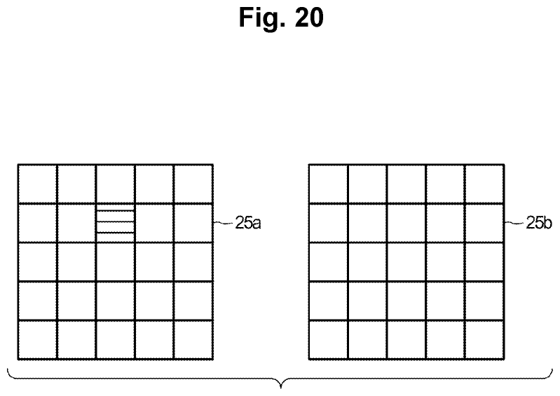

The quantization table 1231 as illustrated in FIG. 18 is obtained by quantizing the coordinates of each player stored in the positional relationship table 1221. Two-dimensional histograms 1232 created from the quantized position coordinates and the positional relationship w of the players are as illustrated in FIG. 19 for the player 3a, for example. Since all the values are “0” for the player 3b, illustration thereof is omitted. Heat maps created from these two-dimensional histograms 1232 are a heat map 25a for the player 3a and a heat map 25b for the player 3b as illustrated in FIG. 20. In FIG. 20, the white frame indicates that the value is “0”, while the horizontal stripes indicates that the value is “1”. By outputting the thus created heat maps 25a and 25b, the user who views them can understand that the player 3a was cornering the player 3b at the position (u=2, yv1) in the ring.

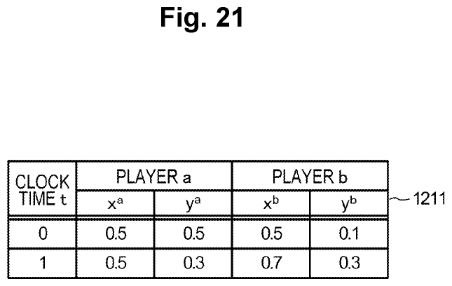

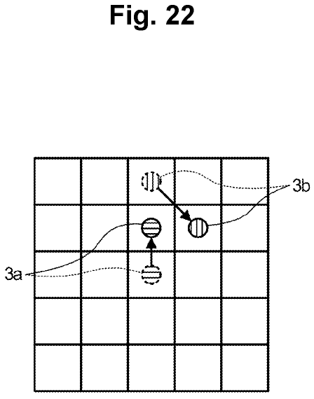

FIG. 21 is a diagram illustrating another example of storage content in the position information table 1211. FIG. 22 is a schematic view illustrating motions of two players corresponding to the storage content in FIG. 21. In other words, a situation in which the player 3a is not cornering the player 3b is illustrated here for comparison.

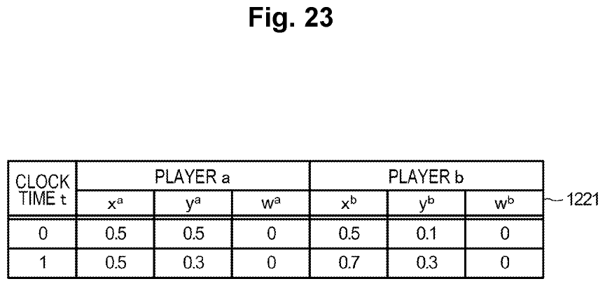

In this example, both the players 3a and 3b do not satisfy the region condition at the clock time t=0, and the positional relationship is thus w^{a}=w^{b}=0. Since both the player 3a and the player 3b do not satisfy the region condition similarly at the clock time t=1 as well, the positional relationship is w^{a}=w^{b}=0. As a result, the positional relationship table 1221 is as illustrated in FIG. 23.

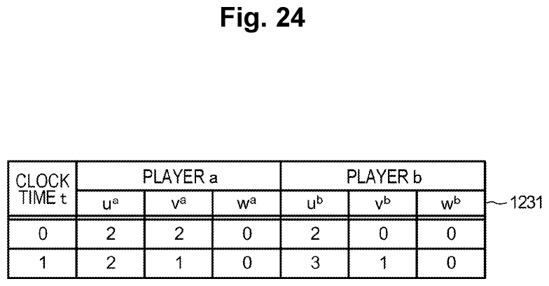

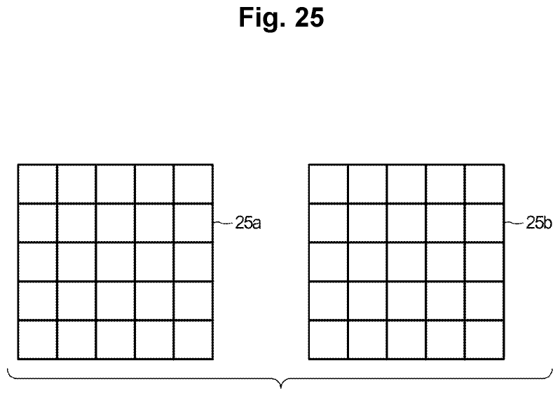

The quantization table 1231 as illustrated in FIG. 24 is obtained by quantizing the coordinates of each player stored in the positional relationship table 1221. If two-dimensional histograms 1232 are created from the quantized position coordinates and the positional relationship w of the players, all the values for both the players 3a and 3b are “0”, and the created heat map are thus the heat maps 25a and 25b including only white frames as illustrated in FIG. 25. By outputting the thus created heat maps 25a and 25b, the user who views them can understand that both the player 3a and the player 3b are not cornering the counterpart.

As described above in detail, according to the sport play situation determination device according to the first embodiment of the present invention, the positional relationship extraction unit 112 uses the determination expression for determining whether a predetermined sport play situation has been achieved on the basis of the position of each of a plurality of sport players, for example, the player a and the player b and extracts the positional relationship of the plurality of sport players, and the positional relationship aggregation unit 113 aggregates the extracted positional relationship of the plurality of sport players and creates the sport play situation display representing the aggregated positional relationship, for example, a heat map. Then, the sport play situation determination device presents, by the output unit 114, the created sport play situation display to the user.

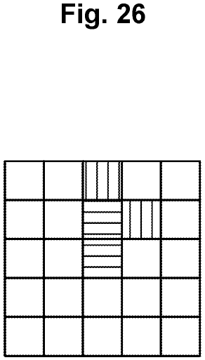

Therefore, according to the first embodiment, it is possible to determine a sport play situation that is a play situation such as superiority, inferiority, or the like in a sport which a plurality of players play. FIG. 26 is a diagram illustrating motions of each player by a heat map according to the conventional method. The heat map is obtained by superimposing a heat map of the player a illustrated by the horizontal stripes and a heat map of the player b illustrated by the vertical stripes. Both in a case where the two players move as illustrated in FIG. 16 and in a case where the two players moves as illustrated in FIG. 22, the heat map as illustrated in FIG. 26 is obtained according to the conventional method. Therefore, it is not possible to determine whether or not one of the players is cornering the other player against a corner or a rope side. On the other hand, the sport play situation determination device according to the present embodiment can determine whether such a situation has been achieved or has not been achieved.

Also, the positional relationship extraction unit 112 determines a situation in which a first sport player who is the player a, for example, is cornering a second sport player who is the player b, for example, against a specific position by using the region determination expression for determining whether or not the first sport player is located at the specific position from the position of the first sport player and the cornering determination expression for determining whether or not the first sport player located at the specific position is cornering the second sport player from the position of the first sport player and the position of the second sport player.

Therefore, it is possible to determine the sport play situation in which the first sport player is cornering the counterpart second sport player at the specific position. Also, since it is possible to perform the determination based on the cornering determination expression only in a case in which the first sport player is located at a specific position after determining whether the first sport player is located at the specific position by the region determination expression, the amount of calculation can be reduced.

Note that in a case where the sport is boxing, the specific position includes a corner region and a rope-side region of a ring, and the cornering determination expression includes a determination expression for the corner region and a determination expression for the rope-side region.

Therefore, it is possible to determine the sport play situation in which the first sport player is cornering the counterpart second sport player against the corner region or the rope-side region of the ring. Additionally, it is possible to simplify the determination expressions by preparing separate determination expressions for the corner region and the rope-side region.

Also, the positional relationship aggregation unit 113 creates, as sport play situation display, the heat maps 25a and 25b by dividing the region where the sport is performed into a plurality of sectioned regions for each of the plurality of sport players, and the heat map 25a for the cornering sport player explicitly indicates the sectioned region at the position where the sport player is located.

Therefore, the user who views the heat maps can easily understand that which of the players was cornering the counterpart player and which position in the ring that happened.

### Second Embodiment

Next, a second embodiment of the present invention will be described. The present embodiment is an exemplary case where a situation in which a player is pushing a counterpart in boxing is determined. In the following description, the same parts as those in the first embodiment will be denoted by the same reference signs as those in the first embodiment, and the description thereof will be omitted. Hereinafter, differences from the first embodiment will be described.

### (Configuration)

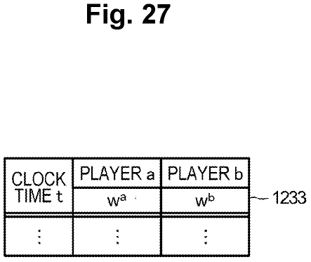

FIG. 27 is a diagram illustrating an example of a storage configuration of an aggregation table 1233 stored in an aggregation result storage unit 123 according to the present embodiment. In the present embodiment, the aggregation table 1233 stores the positional relationship w of each player in association with the clock time t.

In addition, initial setting values acquired by a position information input unit 111 are determination expression parameter setting values (K2, K3, K4) in the present embodiment.

### (Operation)

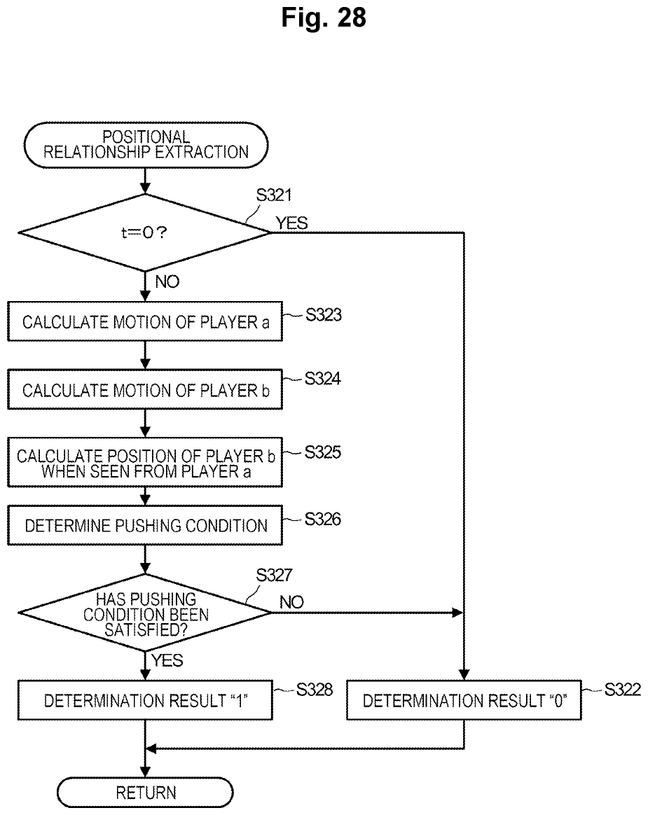

FIG. 28 is a flowchart illustrating details of a positional relationship extraction sub-routine according to the second embodiment. A processor 11A obtains a determination result “0” for both a player a and a player b (Step S322) for the coordinates at a processing target clock time t of “0” in data as a target of processing stored in a position information table 1211 of the position information storage unit 121 (Step S321). Then, the processor 11A stores, in the position information table 1211 of the position information storage unit 121, the determination result “0” as a positional relationship w^{a} in association with coordinates (x^{a}, y^{a}) of the player a and the determination result “0” as a positional relationship w^{b} in association with coordinates (x^{b}, y^{b}) of the player b for the clock time t=0.

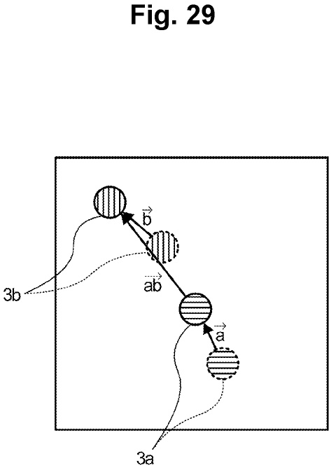

On the other hand, the processor 11A calculates a motion of each player at a clock time t other than “0”. FIG. 29 is a schematic view for explaining a motion of each player. In FIG. 29, the dashed-line circles are the positions of the players a (3a) and the player b (3b) at a certain clock time t=n, and the solid-line circles are the positions of the players a and b (3a and 3b) at the clock time t=n+1.

The processor 11A calculates a motion of the player 3a at each clock time of t>0 as follows first (Step S323).

$$\vec{{a}_{t}} = ( {x}_{t}^{a} - {x}_{t - 1}^{a} , {y}_{t}^{a} - {y}_{t - 1}^{a} ) \qquad [ Math . 7 ]$$

Also, the processor 11A calculates a motion of the player 3b at each clock time of t>0 as follows (Step S324).

$$\vec{{b}_{t}} = ( {x}_{t}^{b} - {x}_{t - 1}^{b} , {y}_{t}^{b} - {y}_{t - 1}^{b} ) \qquad [ Math . 8 ]$$

Furthermore, the processor 11A calculates the position of the player 3b when seen from the player 3a at each clock time of t>0 as follows (Step S325).

$$\vec{a {b}_{ι}} = ( {x}_{t}^{b} - {x}_{t}^{a} , {y}_{t}^{b} - {y}_{t}^{a} ) \qquad [ Math . 9 ]$$

Then, the processor 11A determines whether the player 3a is pushing the player 3b, or on the contrary, whether the player 3b is in a situation in which the player 3b is pushing the player 3a by the following pushing condition determination expression from the calculated motion of the player 3a, motion of the player 3b, and position of the player 3b when seen from the player 3a (Step S326). In the determination expression, the determination expression parameter setting values (K2, K3, K4) stored in the temporary storage unit are used.

$$Pushing condition 1 : K 2 \leq ‖ \vec{{a}_{t}} ‖ \leq K 3 , K 2 \leq ‖ \vec{{b}_{t}} ‖ \leq K 3 , K 2 \leq ‖ \vec{{ab}_{t}} ‖ \leq K 3 \qquad [ Math . 10 ]$$

$$Pushing condition 2 : \frac{\vec{{a}_{t}}}{‖ \vec{{a}_{t}} ‖} \cdot \frac{\overline{{b}_{t}}}{‖ \overline{{b}_{t}} ‖} > K 4$$

$$Pushing condition 3 a : \frac{\vec{{a}_{t}}}{‖ \vec{{a}_{t}} ‖} \cdot \frac{\vec{{ab}_{t}}}{‖ \vec{{ab}_{t}} ‖} > K 4 , \frac{\vec{{b}_{t}}}{‖ \vec{{b}_{t}} ‖} \cdot \frac{\vec{{ab}_{t}}}{‖ \vec{{ab}_{t}} ‖} > K 4$$

$$Pushing condition 3 b : \frac{\vec{{a}_{t}}}{‖ \vec{{a}_{t}} ‖} \cdot \frac{\vec{{ab}_{t}}}{‖ \vec{{ab}_{t}} ‖} < - K 4 , \frac{\vec{{b}_{t}}}{‖ \vec{{b}_{t}} ‖} \cdot \frac{\vec{a {b}_{t}}}{‖ \vec{{ab}_{t}} ‖} < - K 4$$

The processor 11A determines whether or not the motions of the players at each clock time satisfy the pushing condition (Step S327). Specifically, the processor 11A determines whether the pushing conditions 1, 2, and 3a are satisfied or the pushing conditions 1, 2, and 3b are satisfied.

The processor 11A regards the player 3a as pushing the player 3b and obtains the determination result “1” for the player 3a for the clock time at which it is determined that the pushing conditions 1, 2, and 3a are satisfied, or regards the player 3b as pushing the player 3a and obtains the determination result “1” for the player 3b for the clock time at which it is determined that the pushing conditions 1, 2, and 3b are satisfied (Step S328). For the clock time t at which it is determined that the pushing conditions 1, 2, and 3a are satisfied, the processor 11A stores, in the position information table 1211 in the position information storage unit 121, the determination result “1” as a positional relationship w^{a} in association with coordinates (x^{a}, y^{a}) of the player a and the determination result “0” as a positional relationship w^{b} in association with coordinates (x^{b}, y^{b}) of the player b for the clock time t. For the clock time t at which it is determined that the pushing conditions 1, 2, and 3b are satisfied, the processor 11A stores, in the position information table 1211 in the position information storage unit 121, a determination result “1” as a positional relationship w^{b} in association with the coordinates (x^{b}, y^{b}) of the player b and the determination result “0” as a positional relationship w^{a} in association with the coordinates (x^{a}, y^{a}) of the player a for the clock time t.

For the clock time t at which it is determined that the pushing conditions are not satisfied, the processor 11A moves on to the above processing in Step S322 and obtains a determination result “0” for both the player a and the player b.

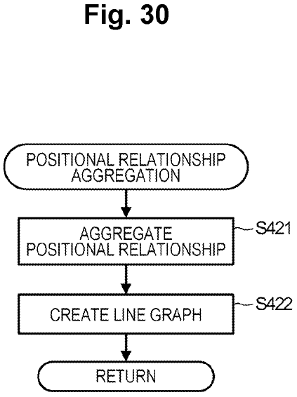

FIG. 30 is a flowchart illustrating details of a positional relationship aggregation sub-routine according to the second embodiment. The processor 11A aggregates the coordinates of the position of each of the players 3a and 3b at each clock time t stored in the position information table 1211 in the position information storage unit 121 (Step S421). The aggregation means ignoring in the present embodiment. As the aggregation results, the processor 11A causes the aggregation result storage unit 123 to store the aggregation table 1233 storing the positional relationships w^{a} and w^{b} of the players 3a and 3b at each clock time t.

Next, the processor 11A creates a line graph in which a horizontal axis represents the clock time t and the vertical axis represents the positional relationship w, for example, in accordance with the storage content in the aggregation table 1233 (Step S422). Thereafter, the processor 11A ends the processing of the positional relationship aggregation sub-routine, moves on to the above processing in Step S5, and outputs the line graph.

Note that the processor 11A may stop at the processing of aggregating the positional relationship that is the basis of the line graph in the positional relationship aggregation sub-routine, and create the line graph in accordance with the storage content in the aggregation table 1233 in the next processing of outputting results in Step S5.

Next, operations of the sport play situation determination device will be described in a specific example. Here, description will be given on the assumption of the determination expression parameter setting expressions (K2=0.1, K3=0.5, K4=0.9), for example.

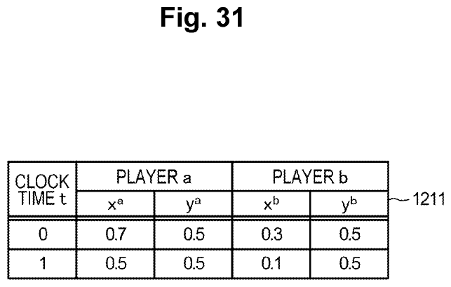

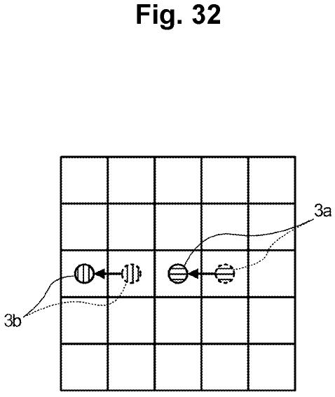

FIG. 31 is a diagram illustrating an example of storage content in the position information table 1211. FIG. 32 is a schematic view illustrating motions of two players corresponding to the storage content in FIG. 31. In FIG. 32, the dashed-line circles are the positions of the players 3a and 3b at the clock time t=0, while the solid-line circles are the positions of the players 3a and 3b at the clock time t=1.

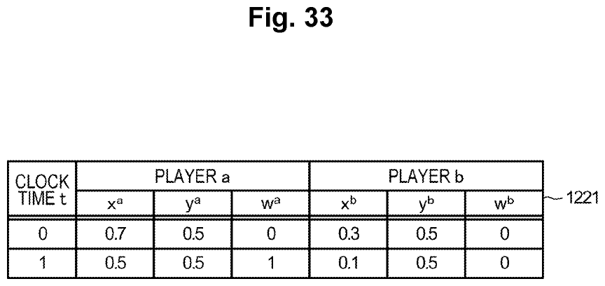

In this example, the positional relationship w^{a}=w^{b}=0 at the clock time t=0. On the other hand, the player 3a satisfies the pushing conditions at the clock time t=1, and the positional relationship is thus w^{a}=1. The player 3b does not satisfy the pushing conditions, the positional relationship is thus w^{b}=0. As a result, the positional relationship table 1221 is as illustrated in FIG. 33.

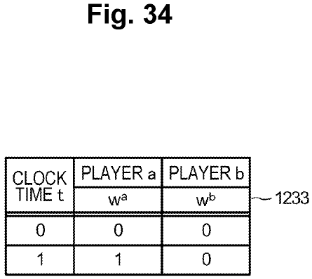

The aggregation table 1233 as illustrated in FIG. 34 is obtained by aggregating the coordinates of each player stored in the positional relationship table 1221.

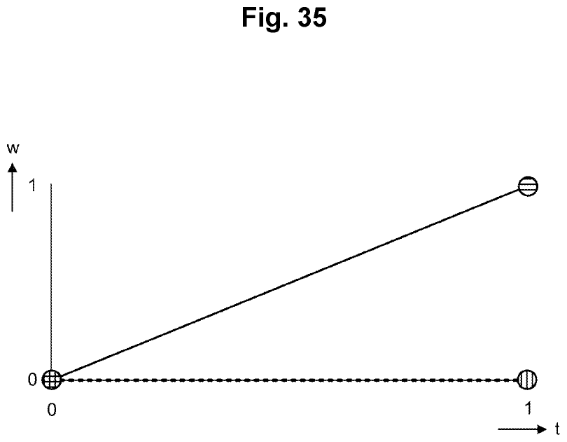

The line graphs of the player 3a and 3b created from the storage content in the aggregation table 1233 are as illustrated in FIG. 35. Since the horizontal axis of the line graphs is a clock time t, and the vertical axis is the positional relationship w (w^{a}, w^{b}), the inclination of the line of the player 3a is large, and the inclination of the line of the player 3b is “0”. By outputting the thus created lines, the user who views them can understand that the player 3a was pushing the player 3b (at the clock time t=1).

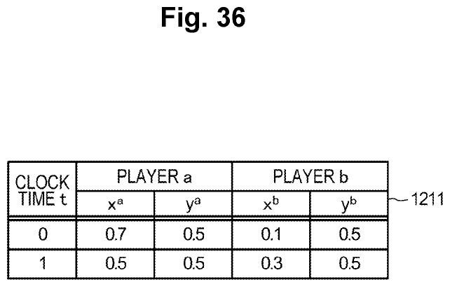

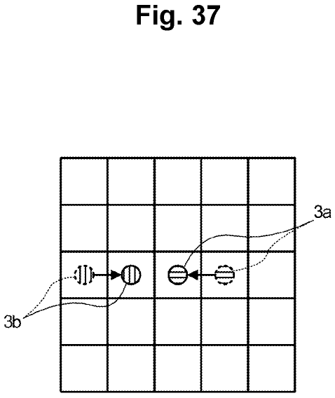

FIG. 36 is a diagram illustrating another example of storage content in the position information table 1211. FIG. 37 is a schematic view illustrating motions of two players corresponding to the storage content in FIG. 36. In other words, a situation in which both the players are not pushing the counterpart players is illustrated here for comparison.

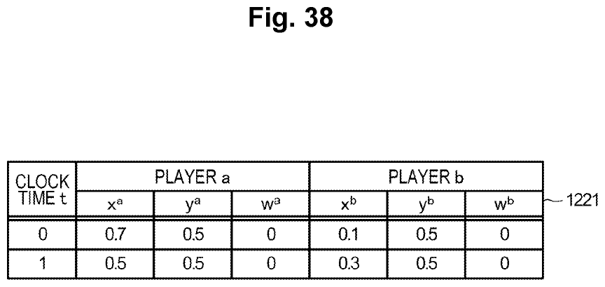

In this example, the positional relationship w^{a}=w^{b}=0 at the clock time t=0. Since both the player 3a and the player 3b do not satisfy the pushing conditions at the clock time t=1 as well, the positional relationship is w^{a}=w^{b}=0. As a result, the positional relationship table 1221 is as illustrated in FIG. 38.

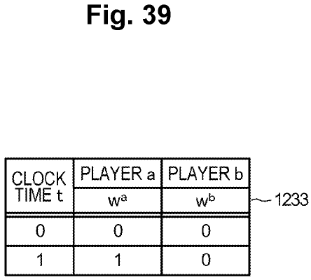

The aggregation table 1233 as illustrated in FIG. 39 is obtained by aggregating the coordinates of each player stored in the positional relationship table 1221.

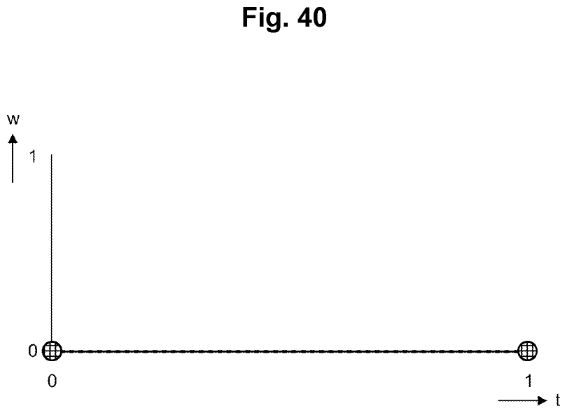

The line graphs of the player 3a and 3b created from the storage content in the aggregation table 1233 are as illustrated in FIG. 40. The inclinations of the lines of both the player 3a and the player 3b are “0”. By outputting the thus created lines, the user who views them can understand that both the player 3a and the player 3b are not pushing the counterparts.

As described above in detail, the positional relationship extraction unit 112 extracts the positional relationship of the plurality of sport players by using the determination expression for determining whether the predetermined sport play situation has been achieved on the basis of the position of each of the plurality of sport players, for example, the player a and the player b, and the positional relationship aggregation unit 113 aggregates the extracted positional relationship of the plurality of sport players and creates the sport play situation display representing the aggregated positional relationship, for example, the line graph in the second embodiment of the present invention as well. Then, the sport play situation determination device presents, by the output unit 114, the created sport play situation display to the user.

Therefore, it is possible to determine the sport play situation that is a play situation such as superiority, inferiority, and the like in a sport which a plurality of players play similarly to the first embodiment, according to the present embodiment as well.

Also, the positional relationship extraction unit 112 determines the situation in which a first sport player, for example, the player a, is pushing a second sport player, for example, a player b, by using the pushing determination expression for determining whether or not the first sport player is pushing the second sport player from the time-series positional relationship of the first sport player himself/herself, the time-series positional relationship of the second sport player himself/herself, and the time-series positional relationship between the first sport player and the second sport player.

Therefore, it is possible to determine a sport play situation in which the second sport player is pushed with a pressure from the counterpart first sport player.

Also, the positional relationship aggregation unit 113 creates the line graph for each of the plurality of sport players, in which the vertical axis represents the positional relationship and the horizontal axis represents the clock time as sport play situation display, and in the line graph, the inclination of the line of the pushing sport player is large, and the inclination of the line of the sport player who is not pushing is “0”.

Therefore, the user who views the line graph can understand which of the players was pushing the counterpart player and what time that happened.

### Other Embodiments

Note that this invention is not limited to the above-described embodiments.

For example, the positional relationship aggregation unit 113 can apply various aggregation methods such as combining quantization of a coordinate direction and a clock time direction.

Also, the sport is not limited to martial arts such as boxing.

Furthermore, the number of players can also be expanded to three or more by increasing the determination expressions.

The flow of the processing described with reference to each flowchart is not limited to the described procedure, and the order of some steps may be replaced, some steps may be performed simultaneously in parallel, or the processing content of some steps may be modified.

In addition, the method described in each embodiment can be stored as a processing program (software means) that can be executed by a computer in a recording medium such as a magnetic disk (e.g. Floppy (registered trademark) disk or hard disk), an optical disc (e.g. CD-ROM, DVD, or MO), or a semiconductor memory (e.g. ROM, RAM, or flash memory) or can be distributed by being transmitted through a communication medium. Note that the program stored on the medium side also includes a setting program for configuring, in the computer, the software means (including not only execution program but also table and data structure) to be executed by the computer. The computer that implements the present device executes the above-described processing by reading the programs recorded in the recording medium, constructing the software means by a setting program as needed, and controlling the operation by the software means. Note that the recording medium described in the present specification is not limited to a recording medium for distribution, but includes a storage medium such as a magnetic disk or a semiconductor memory provided in the computer or in a device connected via a network.

In short, the present invention is not limited to the above-described embodiments without any change and can be embodied by modifying the configurational elements within a range without departing from the gist of the present invention at the implementation stage. Further, various inventions can be formed by appropriately combining a plurality of components disclosed in the above embodiments. For example, some components may be deleted from all the components described in the embodiments. Moreover, constituent elements in different embodiments may be appropriately combined.

### REFERENCE SIGNS LIST

3a, 3b Player
11 Processing unit
11A Processor
11B Program memory
12 Data memory
13 Input/output interface
14 Communication interface
15 Bus
16 Input device
17 Output device
20 Ring region
21 Corner region
22 Rope-side region
23 Corner cornering range
24 Rope-side cornering range
25a, 25b Heat map
111 Position information input unit
112 Positional relationship extraction unit
113 Positional relationship aggregation unit
114 Output unit
121 Position information storage unit
122 Positional relationship storage unit
123 Aggregation result storage unit
231 Rectangle
232 Right-angle triangle
1211 Position information table
1221 Positional relationship table
1231 Quantization table
1232 Two-dimensional histogram
1233 Aggregation table

1. A sport play situation determination device comprising:
a positional relationship extraction unit, implemented using one or more processors, configured to extract a positional relationship of a plurality of sport players by using a determination expression for determining whether a predetermined sport play situation has been achieved on the basis of a position of each of the plurality of sport players;
a positional relationship aggregation unit, implemented using one or more processors, configured to aggregate the positional relationship of the plurality of sport players extracted by the positional relationship extraction unit and create a sport play situation display representing the aggregated positional relationship; and
an output unit, implemented using one or more processors, configured to present the sport play situation display created by the positional relationship aggregation unit.

2. The sport play situation determination device according to claim 1, wherein the positional relationship extraction unit uses (i) a region determination expression for determining whether or not a first sport player is located at a specific position from a position of the first sport player, and (ii) a cornering determination expression for determining whether or not the first sport player located at the specific position is cornering a second sport player from the position of the first sport player and a position of the second sport player to determine a situation in which the first sport player is cornering the second sport player against the specific position.

3. The sport play situation determination device according to claim 2, wherein:
the sport is boxing,
the specific position includes a corner region and a rope-side region of a ring, and
the cornering determination expression includes a determination expression for the corner region and a determination expression for the rope-side region.

4. The sport play situation determination device according to claim 2, wherein:
the positional relationship aggregation unit is configured to create a heat map by dividing a region where the sport is performed into a plurality of sectioned regions for each of the plurality of sport players as the sport play situation display, and
the heat map of the cornering sport player explicitly indicates the sectioned region where the sport player is located.

5. The sport play situation determination device according to claim 1, wherein the positional relationship extraction unit is configured to determine situation in which the first sport player is pushing the second sport player by using a pushing determination expression for determining whether or not the first sport player is pushing the second sport player from a time-series positional relationship of the first sport player himself/herself, a time-series positional relationship of the second sport player himself/herself, and a time-series positional relationship between the first sport player and the second sport player.

6. The sport play situation determination device according to claim 5,
wherein:
the positional relationship aggregation unit is configured to create a line graph for each of the plurality of sport players, in which a vertical axis represents the positional relationship and a horizontal axis represents a clock time as the sport play situation display, and
in the line graph, an inclination of a line of the pushing sport player is greater than zero while an inclination of a line of the sport player who is not pushing the other sport player is zero.

7. A sport play situation determination method of a sport play situation determination device that determines a situation of a sport, the method comprising:
extracting a positional relationship of a plurality of sport players by using a determination expression for determining whether a predetermined sport play situation has been achieved on the basis of a position of each of the plurality of sport players;
aggregating the extracted positional relationship of the plurality of sport players and creating a sport play situation display representing the aggregated positional relationship; and
presenting the created sport play situation display.

8. A non-transitory computer readable medium storing instructions of a sport play situation determination program, wherein execution of the instructions causes a computer to perform operations comprising:
extracting a positional relationship of a plurality of sport players by using a determination expression for determining whether a predetermined sport play situation has been achieved on the basis of a position of each of the plurality of sport players;
aggregating the extracted positional relationship of the plurality of sport players and creating a sport play situation display representing the aggregated positional relationship; and
presenting the created sport play situation display.

9. The non-transitory computer readable medium of claim 8, wherein (i) a region determination expression for determining whether or not a first sport player is located at a specific position from a position of the first sport player, and (ii) a cornering determination expression for determining whether or not the first sport player located at the specific position is cornering a second sport player from the position of the first sport player and a position of the second sport player are used to determine a situation in which the first sport player is cornering the second sport player against the specific position.

10. The non-transitory computer readable medium of claim 9, wherein:
the sport is boxing,
the specific position includes a corner region and a rope-side region of a ring, and
the cornering determination expression includes a determination expression for the corner region and a determination expression for the rope-side region.

11. The non-transitory computer readable medium of claim 9, wherein:
execution of the instructions causes the computer to perform operations comprising creating a heat map by dividing a region where the sport is performed into a plurality of sectioned regions for each of the plurality of sport players as the sport play situation display, and
the heat map of the cornering sport player explicitly indicates the sectioned region where the sport player is located.

12. The non-transitory computer readable medium of claim 8, wherein execution of the instructions causes the computer to perform operations comprising determining a situation in which the first sport player is pushing the second sport player by using a pushing determination expression for determining whether or not the first sport player is pushing the second sport player from a time-series positional relationship of the first sport player himself/herself, a time-series positional relationship of the second sport player himself/herself, and a time-series positional relationship between the first sport player and the second sport player.

13. The non-transitory computer readable medium of claim 12, wherein execution of the instructions causes the computer to perform operations comprising creating a line graph for each of the plurality of sport players, in which a vertical axis represents the positional relationship and a horizontal axis represents a clock time as the sport play situation display, and in the line graph, an inclination of a line of the pushing sport player is greater than zero while an inclination of a line of the sport player who is not pushing the other sport player is zero.
